(19) United States
(12) Patent Application Publication
(10) Pub. No.: US 2004/0175542 A1
(43) Pub. Date: Sep. 9, 2004

(54) Polyester conjugate filament thick-fine yarn fabric and method for production thereof

(76) Inventor: Nobuyoshi Miyasaka, Osaka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/482,077

(22) PCT Filed: Apr. 25, 2003
(86) PCT No.: PCT/JP03/05391

(30) Foreign Application Priority Data
May 2, 2002 (JP) 2002-130388

(51) Int. Cl. B32B 31/00; B32B 1/00; B32B 33/00

(52) U.S. Cl. 428/141; 442/189; 442/199; 442/200; 442/201; 442/311; 442/308; 442/361; 442/362; 442/363; 442/364; 428/373; 264/167; 264/171.1; 264/171.11; 428/399

(57) ABSTRACT

A fabric having worsted yarn fabric-like hand and appearance and a satisfactory stretchability, is obtained by melt-spinning two types of polyesters, different in intrinsic viscosity from each other, to produce a conjugate multifilament yarn; winding-up the yarn at a speed of 1,000 to 4,500 m/min; unwinding the wound yarn; unevenly drawing the yarn at a draw ratio lower than a natural draw ratio thereof to produce a thick-and-thin yarn; forming a fabric from the yarn; and applying a mass reduction treatment with an alkali to the fabric with a mass reduction of 3 to 30 mass %, to cause a plurality of cracks extending in a direction crossing the filament axis to be formed on the peripheries of individual filaments of the yarn.

### TECHNICAL FIELD

This invention relates to a polyester conjugate filament thick-and-thin yarn fabric and a process for producing the same. More particularly, the invention relates to a polyester conjugate filament thick-and-thin yarn fabric having hand and appearance like those of a natural fiber spun yarn fabric, particularly a worsted yarn fabric, and having high stretchability, and a process for producing the fabric.

### BACKGROUND ART

Development of fabrics having hand and appearance like those of a worsted yarn fabric by use of a polyester false twisted yarn has been attempted in the past. However, such polyester fabrics of the prior art are by far inferior in hand, appearance and stretchability to the worsted yarn fabrics.

Therefore, Japanese Unexamined Patent Publication (Kokai) Nos. 5-222669 and 2001-329447 propose to combine high shrinkage polyester yarns with polyester thick-and-thin filament yarns and to constitute a fabric by use of the combined filament yarns in order to obtain a polyester worsted yarn fabric having hand, appearance and stretchability like those of the worsted yarn fabric. Such a fabric has hand analogous to that of the natural fiber spun yarn fabric but its appearance is obviously different from appearance of the natural fiber spun yarn fabric and is quite unsatisfactory. In addition, stretchability of the polyester combined yarn fabric is not sufficient and the shape stability is so low that shape collapse is likely to occur.

To impart hand, appearance and stretchability analogous to those of the worsted yarn fabric to the polyester fiber yarn fabric, the patent references described above propose to form fine pores inside the polyester fiber, to prepare combined filament yarns having different degree of shrinkage or composite false-twisted yarns by use of the porous fiber, and to constitute a fabric by the yarns so as to impart puff hand and flexibility (a soft hand) to the polyester fiber yarn fabric. However, hand, appearance and stretchability of the polyester fiber yarn fabric so obtained are still unsatisfactory in comparison with those of the worsted yarn fabric.

To obtain a polyester fiber yarn fabric having high stretchability, on the other hand, Japanese Unexamined Patent Publication (Kokai) No. 2000-144518, for example, proposes to constitute a fabric by use of a side-by-side type composite fiber prepared by using two kinds of polyesters having mutually different viscosities. However, hand, appearance and stretchability of the resulting fabric are still unsatisfactory in comparison with those of the worsted yarn fabric.

As described above, development of polyester fiber yarn fabrics having hand, appearance and stretchability analogous to those of a natural fiber spun yarn fabric, particularly a worsted yarn fabric, has been desired strongly.

### DISCLOSURE OF THE INVENTION

It is an object of the present invention to provide a polyester conjugate filament thick-and-thin yarn fabric having hand and appearance analogous to those of a natural fiber spun yarn fabric, particularly a worsted yarn fabric, and having practically high stretchability, and a process for producing the fabric with high efficiency.

The polyester conjugate filament thick-and-thin yarn fabric, of the present invention comprises side-by-side type conjugate multifilament yarns and eccentric core-in-sheath type conjugate multifilament yarns of which, a portion of the peripheral surface of the each individual filament is formed by a portion of the eccentric core portion, characterized in that a plurality of individual filaments, from which the conjugate multifilament yarn is formed, are thick-and-thin filaments each comprising a plurality of thick portions and a plurality of thin portions each formed along the longitudinal axis direction of each individual filament, arranged alternately with each other and having uneven lengths, and, when the conjugate multifilament yarn is observed by an electron microscope, an average value of an apparent thick-to-thin ratio represented by a ratio of a largest thickness to a smallest thickness of the yarn measured in a region of a length of 10 cm of the yarn, is 1.05 or more, and each of the plurality of individual filaments, from which the conjugate multifilament yarn is formed, has a plurality of cracks formed in the peripheral surface of the filament and extending in a direction intersecting the filament axis.

In the polyester conjugate filament thick-and-thin yarn fabric of the present invention, preferably each crack is formed along a plane intersecting, substantially at right angles, the axis direction of the individual filament on which the crack is formed.

In the polyester conjugate filament thick-and-thin yarn fabric of the present invention, the cracks preferably have an average width of 0.1 μm or more.

In the polyester conjugate filament thick-and-thin yarn fabric of the present invention, the cracks preferably have an average straight line distance between the both ends thereof in the range of from ¼ to 1/1 of the average diameter of the individual filaments on which the cracks are formed.

In the polyester conjugate filament thick-and-thin yarn fabric of the present invention, the cracks are preferably formed at intervals of 2 mm or less along the axis direction of the individual filament on which the cracks are formed.

In the polyester conjugate filament thick-and-thin yarn fabric of the present invention, the polyester conjugate filament thick-and-thin yarns are preferably contained in a content of 30% by mass based on the total mass of all the yarns from which the fabric is formed.

The process of the present invention for producing a polyester conjugate filament thick-and-thin yarn fabric comprises:

separately melting a polyester resin having an intrinsic viscosity of 0.3 to 0.9, determined in orthochlorophenol at 30° C., and another polyester resin having an intrinsic viscosity of 0.1 to 0.5 above the intrinsic viscosity of the former polyester resin; extruding the melts of the two types of the polyester resins through a side-by-side type conjugate multifilament-forming spinneret or an eccentric core-in-sheath type conjugate multifilament-forming spinneret, to form conjugate multifilaments; winding up the resultant side-by-side type undrawn conjugate multifilament yarn or eccentric core-in-sheath type undrawn conjugate multifilament yarn at a speed of 1,000 to 4,500 m/minute; while unwinding the wound undrawn conjugate multifilament yarn, unevenly drawing the unwound undrawn conjugate multifilament yarn in the filament axis direction at a draw ratio lower than the natural draw ratio of the undrawn multifilament yarn represented by a lowest draw ratio in a draw ratio range in which the undrawn multifilament yarn can be drawn at room temperature without necking of the filaments, to produce a drawn thick-and-thin yarn comprising a plurality of drawn thick-and-thin conjugate filaments each having a plurality of thick portions and a plurality of thin portions arranged alternately with each other and having uneven lengths, respectively, while the uneven drawing procedure is controlled so that when the resultant drawn thick-and-thin yarn is observed by an electron microscope, an apparent thick-to-thin ratio represented by a ratio of a largest thickness to a smallest thickness of the yarn in a region in a length of 10 cm of the yarn, is 1.05 or more;

producing a fabric comprising the drawn conjugate multifilament thick-and-thin yarn; and

subjecting the fabric to a mass-reduction treatment with an alkali at a mass-reduction of 3% or more but not more than 30%, to thereby causing a plurality of cracks to be formed in the peripheral surfaces of the individual conjugate polyester filaments in a direction intersecting the axes of the individual conjugate polyester filaments.

In the process of the present invention for producing polyester conjugate filament thick-and-thin yarn fabric, a difference in the intrinsic viscosity between the two polyester resins for forming the conjugate filaments is preferably 0.1 to 0.5.

In the process of the present invention for producing polyester conjugate filament thick-and-thin yarn fabric, preferably one of the two types of filament-forming polyester resins comprises a polyethylene terephthalate copoloymer or a polybutylene terephthalate copolymer containing 30 molar % or less of at least one copolymerized comonomer selected from the group consisting of isophthalic acid, diphenyldicarboxylic acids, naphthalene dicarboxylic acids, 5-sodium sulfoisophthalic acid, adipic acid, sebacic acid, parahydroxybenzoic acid, p-(β-hydroxy)benzoic acid, trimethylene glycol, hexamethylene glycol, neopentyl glycol, bisphenol A and polytetramethylene glycol, and the other one of the two types of polyester resins consists essentially of a polyethylene terephthalate or a polybutylene terephthalate.

In the process of the present invention for producing polyester conjugate filament thick-and-thin yarn fabric, the mass ratio of the two types of filament-forming polyester resins to each other is preferably in the range of from 20:80 to 80:20.

### BRIEF DESCRIPTION OF THE DRAWINGS

FIG. 1 is an explanatory cross-sectional profile of an example of an eccentric core-in-sheath type conjugate filament usable for a polyester conjugate filament thick-and-thin yarn fabric of the invention.

FIG. 2 is an explanatory peripheral surface view of an example of an individual polyester conjugate thick-and-thin filament of the present invention.

FIG. 3 is an explanatory view showing an embodiment of a drawing step in a process for producing a thick-and-thin yarn usable for the polyester conjugate filament thick-and-thin yarn fabric of the present invention.

### BEST MODE FOR CARRYING OUT THE INVENTION

The polyester conjugate filament thick-and-thin yarns (which will be referred to as “thick-and-thin yarn of the invention” hereinafter) usable for the polyester conjugate filament thick-and-thin yarn fabric of the invention (which will be referred to as “thick-and-thin yarn fabric of the invention” hereinafter) are selected from side-by-side type conjugate multifilament yarns and an eccentric core-in-sheath type conjugate multifilament yarns in which a part of the core portion of an individual filament forms a part of a peripheral surface of the individual filament, formed from two types of fiber-forming polyesters different in intrinsic viscosities from each other. In each of the individual conjugate filaments from which the conjugate multifilament yarns are formed, a plurality of thick portions and a plurality of thin portions are alternately formed, and the thick portions and the thin portions have uneven lengths, respectively. A plurality of thick portions and a plurality of thin portions are formed as a whole in the yarn consisting of such uneven thick-and-thin multi-filaments, and the thick portions and the thin portions have uneven lengths, respectively.

As the fiber-forming polyesters from which the thick-and-thin filaments of the invention are formed, it is preferred to use a polyethylene terephthalate polyester containing a terephthalate unit as a main repeating units and a polybutylene terephthalate polyester containing butylene terephthalate units as a main repeating units.

The fiber-forming polyesters having mutually different intrinsic viscosities can be selected by selecting those having different degrees of polymerization among the same type of polyesters, and those polyesters that are different at least in their acid component and their diol component among different types of polyesters.

In each of the polyethylene terephthalate polyesters and the polybutylene terephthalate polyesters described above, a small amount, preferably less than 30 mol %, of a different type of carboxylic acid compound or a different type of diol compound may be copolymerized with the terephthalic acid component or with the ethylene glycol or butylenes glycol component, whenever necessary.

Isophthalic acid, diphenyldicarboxylic acid, naphthalenedicarboxylic acid, 5-sodium sulfoisophthalic acid, adipic acid and sebacic acid can be used as the dicarboxylic acid for copolymerisation. Parahydroxybenzoic acid and γ-(β-hydroxy)benzoic acid can be used as the oxycarboxylic acid for copolymerisation. Further, trimethylene glycol, hexamethylene glycol, neopentyl glycol, bisphenol A (inclusive of those compounds in which at least one molecule of ethylene oxide is added to a phenolic hydroxyl group), polyethylene glycol and polytetramethylene glycol can be used as different type of copolymerisable diols.

The fiber-forming polyesters described above may contain one or more kinds members selected from pore-forming agents, cationic dyeing agents, coloration preventing agents, thermal stabilizers, flame-retardants, fluorescent brightening agents, delustering agents, colorants, antistatic agents, hygroscopic agents, antibacterial agents, etc., whenever necessary, within the range where there is no adverse effect on the object of the invention.

The conjugate filament described above must essentially have a side-by-side type composite form or an eccentric core-in-sheath type composite form (in which a part of a core portion forms a part of a peripheral surface of a sheath portion). When such a composite form is employed, and the thick-and-thin individual filament of the invention is crimped, bulkiness and stretchability can be imparted to the thick-and-thin multifilament yarn containing the thick-and-thin individual filaments and to the fabric containing the thick-and-thin multifilament yarn. Of these composite forms, the side-by-side type composite form is used particularly preferably, and excellent stretchability can be imparted to the object fabric when the kinds of the fiber-forming polyesters are selected and combined appropriately.

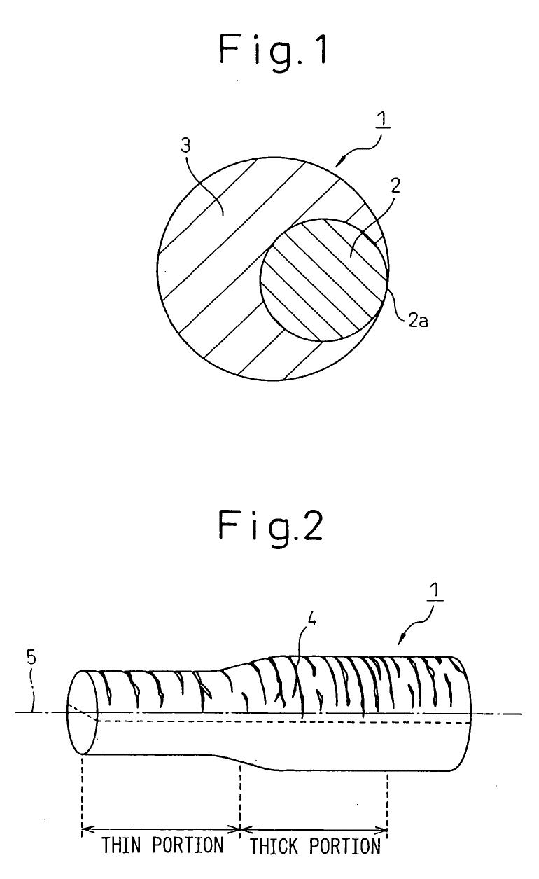

In FIG. 1 showing the cross-sectional profile of the eccentric core-in-sheath type individual conjugate filament, for example, a core portion 2 of the conjugate filament 1 is eccentric with respect to the sheath portion 3 and contained inside a sheath portion 3 and a part 2a of the core portion 2 is exposed outside in such a fashion as to form a part of the peripheral surface of the sheath portion 3. In the thick-and-thin conjugate filament used for the thick-and-thin yarn fabric according to the invention, cracks may be formed on the peripheral surface of the sheath portion or at the exposed portion of the core portion.

The cross-sectional profile of the individual conjugate filament is not particularly limited, and may be any conventional cross-sectional profile such as a circle, a triangle or a circle or triangle hollow cross-sectional profile. For example, it is possible to use a side-by-side type hollow thick-and-thin conjugate filament formed of two types of polymers, and having a round circular cross-sectional profile, for the invention.

In the individual conjugate filament described above, the combination ratio of the two types of fiber-forming polyesters may be selected arbitrarily. However, the weight ratio of the two types of polyesters is preferably 20:80 to 80:20 and more preferably 40:60 to 60:40. The thickness of each of the thick and thin portions of the individual conjugate filament can be measured with an electron microscope. The measuring method includes a method that directly measures them within the field of the electron microscope and a method that measures by use of an electron micrograph.

An apparent thick-and-thin ratio of the multi-filament yarn consisting of a plurality of individual conjugate filaments, as defined below, is at least 1.05 and preferably at least 1.2.

(Definition of Apparent Thick-and-Thin Ratio)

A ratio of the maximum thickness to the minimum thickness in a region of a yarn length of 10 cm when the thick and thin yarn constituting the fabric is observed through an electron microscope is defined as a thick-and-thin ratio of the thick-and thin yarns.

When the thick-and-thin multifilament yarns constituting the thick-and-thin yarn fabric of the invention have a thick-and-thin ratio of 1.05 or more, the thick-and-thin filament yarn fabric according to the invention can exhibit a hand and appearance analogous to those of a natural fiber spun yarn fabric, particularly those of worsted yarn fabric.

When the thick-and-thin ratio as defined above is less than 1.05, the resulting thick-and-thin yarn fabric cannot exhibit a hand and appearance analogous to those of the natural fiber spun yarn fabric. The length of each of the thick and thin portions of the thick-and-thin yarn is uneven. Preferably, however, the thick portion has a length within the range of 10 to 50 mm and a ratio of the length of the thick portion to the length of the thin portion adjacent to the thick portion is within the range of 1/0.5 to 1/30.

In the thick-and-thin yarn fabric according to the invention, cracks are preferably formed on the thick-and-thin conjugate filament in such a fashion as to extend from the peripheral surface of the filament along the fiber axis of the filament in a direction intersecting substantially at right angles a direction of the fiber axis of the filament. Each crack preferably has a depth of at least 0.5 μm, and more preferably from 1.0 to 5.0 μm. Such a crack can provide delicate hand and appearance analogous to those of the worsted yarn fabric. Here, the term “depth” of the crack means a mean value of the maximum depth of the cracks. When the mean depth of the crack is smaller than 0.5 μm, the hand and appearance of the resulting thick-and-thin yarn fabric become inappropriate.

A plurality of cracks is formed on the peripheral surface of the individual polyester conjugate filament usable for the invention, in the direction in which the cracks intersect the filament axis. As typically shown in FIG. 2, the cracks 4 are formed in the direction intersecting the filament axis direction 5 of the filament 1 in such a fashion as to extend from the filament peripheral surface towards the filament axis 5. The depth-wise direction of the crack is preferably formed in a direction intersecting substantially at right angles the filament axis direction of the filament. However, the crack formation direction need not be exactly in the orthogonal direction. For example, the crack formation direction may extend at an angle within about 45° relative to the filament axis towards the filament axis. Incidentally, FIG. 2 shows an example where the cracks are formed in only one component layer of the side-by-side type conjugate filament, but they may be so formed as to extend to both of two component layers.

The cracks are formed at both thick and thin portions of the individual thick-and-thin conjugate filaments. However, a crack distribution is likely to be such that the distribution is high at the thick portions and low at the thin portions. The cracks at the thick portions of the individual filaments are formed preferably in a density of 100 to 500 cracks/mm along the fiber axis and more preferably 200 to 300 cracks/mm. The number of cracks is preferably about 5 cracks per 20 μm length.

The mean width of the cracks is not particularly limited but is preferably at least 0.1 μm, more preferably 0.5 to 3.0 μm and still more preferably 1.0 to 2.0 μm. When the crack width is less than 0.1 μm, hand and appearance of the resulting thick-and-thin filament yarn are not satisfactorily and are unlike those of the worsted yarn fabric. The mean gap between the cracks is not particularly limited, either, but is preferably 1.0 to 6.0 μm and more preferably 2.0 to 5.0 μm. The length of the cracks is not particularly limited. The mean linear distance between both ends of the crack is preferably ¼ to 1/1 of the mean diameter of the filament and more preferably ½ to ¾. When the mean linear distance between both ends of the crack is greater than 1/1 of the mean diameter, the mechanical strength of the resulting individual conjugate filament may become insufficient. When the mean linear distance between both ends of the crack is smaller than ¼ of the mean diameter, hand and appearance of the resulting thick-and-thin filament yarn fabric may become unsatisfactory.

In the present invention, the depth, width and intervals of the crack are measured using an electron microscope, and the mean value at the number of times of measurements n=10 is used.

In the observation through the electron microscope, the mean length of the crack is represented by the linear distance between both ends of the crack on the peripheral surface of the filament. When the crack is formed beyond the semi-circle of the peripheral surface of the individual filament, the linear distance between both ends of the crack is handled as 1/1 of the diameter of the filament. A composite yarn such as spun yarn, composite false twisted yarn, double-twisted yarn, etc, is constituted and a fabric may be constituted from such a yarn.

The fabric texture of the thick-and-thin filament yarn fabric according to the invention is not particularly limited but is preferably a woven fabric or a knitted fabric. To obtain a fabric having hand and appearance analogous to those of the worsted filament yarn fabric, in particular, the fabric texture has preferably a relatively simple woven/knitted texture such as a plain weave structure or its modified textures, a twill texture or its modified textures, a satin weave texture or its modified textures, or the like.

A process for producing the thick-and-thin filament yarn fabric according to the invention will be explained below.

The cracks described above may be so formed as to extend to both of two component layers in the side-by-side type or eccentric core-in-sheath type individual conjugate filaments, and one component layer in which the cracks are formed and other component layers in which the cracks are not formed may exist as a mixture. However, the cracks are preferably formed in only one component layer. When the conjugate filament is the side-by-side type conjugate filament, for example, the cracks are preferably formed in one component layer but not in other layer. In such a case, the resulting conjugate filament has a practically sufficient mechanical strength.

A total size of the multifilament yarn consisting of the conjugate filaments usable in the present invention and a mean individual yarn size are not particularly limited. To impart satisfactory hand and appearance analogous to those of the worsted yarn fabric to the resulting thick-and-thin filament yarn fabric, however, the total size of the yarn is preferably 30 to 300 dtex and more preferably 50 to 150 dtex, and the mean individual filament size is preferably 0.5 to 10.0 dtex and more preferably 2.0 to 6.0 dtex.

The thick-and-thin filament yarn fabric according to the present invention contains the multifilament yarns consisting of the polyester conjugate filaments described above as its constituent yarn. The content is preferably at least 30% by mass and more preferably at least 40% by mass. The form of the polyester conjugate multifilament yarns contained in the thick-and-thin filament yarn fabric of the present invention may be any of a flat yarn (non-twisted yarn), a crimped yarn, an air jet processed yarn, an air confounded yarn and a twisted yarn. These yarns can be freely selected in accordance with the object of use of the fabric. In the thick-and-thin yarn fabric according to the present invention, it is possible to individually use the multifilament yarn, to twist the yarn, whenever necessary and to weave or knit the yarn into the fabric. Alternatively, the fabric can be formed from combined filament yarns, of the multifilament yarns with other filament yarns, or combined yarns such as a composite false twisted yarn or a doubled twisted yarn.

The structure of the thick-and-thin yarn fabric of the present invention is not particularly limited but is preferably a woven fabric or a knitted fabric. To obtain a fabric having hand and appearance analogous to those of the worsted yarn fabric, in particular, the fabric structure has preferably a relatively simple weave or knitting structure such as a plain weave structure or its modified structure, a twill weave structure or its modified structure, a satin weave structure or its modified structure, etc.

In the process for producing the polyester conjugate filament thick-and-thin yarn according to the present invention, first, a polyester resin having an intrinsic viscosity (measured in orthochlorophenol at 30° C.) of 0.3 to 0.9 (preferably 0.4 to 0.8) and a polyester resin having an intrinsic viscosity of 0.1 to 0.5 (preferably by 0.2 to 0.4) above the intrinsic viscosity described above are melted separately. The melts of the two types of the polyester resins are extruded and spun through a spinneret for a side-by-side type conjugate filament or an eccentric core-in-sheath type conjugate filament (in which a portion of the core portion constitutes a portion of the peripheral surface of the sheath portion). The resulting side-by-side type conjugate filament yarn or eccentric core-in-sheath type conjugate filament yarn is wound at a rate of 1,000 to 4,500 m/min and more preferably 1,500 to 2,500 m/min.

Next, the resultant undrawn conjugate multifilament yarn is rewound and drawn non-uniformly in the direction of the filament axis at a draw ratio lower than a natural draw ratio represented by a minimum ratio in a draw ratio region in which a necking phenomenone does not occur at room temperature. In this way, a drawn thick-and-thin yarn consisting of a plurality of drawn thick-and-thin conjugate filaments in which a plurality of thick portions and a plurality of thin portions, each having an uneven length, are alternately formed is produced.

In this instance, the uneven drawing process (in process conditions such as a draw ratio, a drawing temperature, a drawing speed, etc) is controlled so that the mean value of the apparent thick-and-thin ratios represented by the ratio of the maximum thickness to the minimum thickness in a region of the 10 cm length of the yarn described already is at least 1.05, preferably at least 1.2 and more preferably 1.5 to 2.0.

Then, a fabric (a woven fabric or a knitted fabric, for example) containing the drawn conjugate multifilament yarns is produced, and the resulting fabric is subjected to an alkali mass-reduction treatment at a mass reduction ratio of 3 to 30% so as to form a plurality of cracks extending from the peripheral surface of the filaments in a direction intersecting the filament axis on the conjugate polyester individual filaments and to thereby produce the polyester conjugate filament thick-and-thin yarn fabric of the present invention.

In the process of the invention described above, it is essential that one of the two types of the polyesters usable as the starting materials has a low intrinsic viscosity of 0.3 to 0.9, while the other polyester has an intrinsic viscosity of 0.1 to 0.5 above the low intrinsic viscosity polyester. As the low intrinsic viscosity polyester is used, a plurality of cracks extending from the peripheral surface of the section of the low intrinsic viscosity polyester of the polyester conjugate filaments in the fabric in the direction intersecting the filament axis can be formed on the peripheral surface of the section through the alkali mass-reduction treatment described above. Here, when the intrinsic viscosity of the low intrinsic viscosity polyester is greater than 0.9, a sufficient number of cracks having sufficient sizes may not be formed even when the alkali mass-reduction treatment described above is carried out. When the intrinsic viscosity of the low intrinsic viscosity polyester is smaller than 0.3, the mechanical strength of the resulting fabric may become sufficient.

The invention uses particularly the high intrinsic viscosity polyester and the low intrinsic viscosity polyester in which their intrinsic viscosities are mutually different by 0.1 to 0.5, more preferably 0.15 to 0.3, as the two types of fiber-forming polyesters. Further, polyethylene terephthalate type copolymer polyester having an intrinsic viscosity of 0.4 to 1.0 is preferably used as the high intrinsic viscosity polyester, and polyester substantially consisting of ethylene terephthalate and having an intrinsic viscosity of 0.3 to 0.9 is preferably used as the other low intrinsic viscosity polyester. The content mass ratio of the high intrinsic viscosity polyester to the low intrinsic viscosity polyester is preferably within the range of 20:80 to 80:20 and more preferably 40:60 to 60:40. Since the two types of the polyesters are used in combination, the cracks easily develop on the surface of the yarn section consisting of the low intrinsic viscosity polyester when the mass-reduction treatment is applied to the resulting fabric. At the same time, the resulting fabric exhibits excellent stretchability due to the combination described above. When the high intrinsic viscosity polyester is copolymerized while the amount of isophthalic acid or bisphenol A in the acid component is 2 to 10 mol % on the basis of the total acid component, suitable stretchability and flexibility can be imparted to the resulting fabric. Incidentally, the intrinsic viscosity of the polyester is measured in an orthochlorophenol solution at 30° C.

The conjugate form of the individual polyester conjugate filament usable for the present invention is the side-by-side type composite form or the eccentric core-in-sheath type composite form. Of these forms, the side-by-side type composite form is preferred. When the side-by-side type composite form is employed, the resulting thick-and-thin yarn fabric can exhibit excellent stretchability.

At least one member selected from the group consisting of fine pore forming agents, cationic dyes, coloration preventive agents, heat stabilizers, flame retardants, fluorescent whitening agents, delustering agents, colorants, antistatic agents, desiccating agents, antibacterial agents, inorganic fine particles, etc, may be added to each of the two types of the polyesters, whenever necessary, within the range in which there is no adverse effect on the object of the invention as described already.

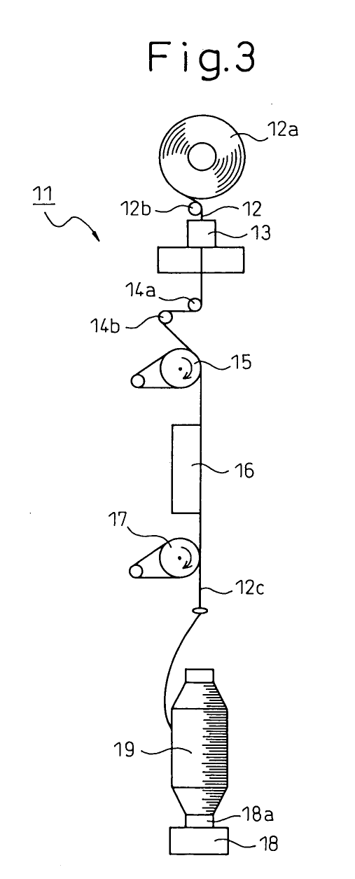

Then, the two types of the polyesters are melt-spun by using a spinneret for side-by-side type or eccentric core-in-sheath type conjugate filaments while the extrusion rates of the polyester components are adjusted appropriately, and the resulting undrawn conjugate multifilament yarn is wound-up at a speed of 1,000 to 2,500 m/min. Then, the undrawn yarn is supplied to a drawing machine such as, for example, the drawing machine 11 shown in FIG. 3.

In the drawing machine 11 shown in FIG. 3, the undrawn yarn 12 is rewound from a cone 12a of the undrawn yarn through a guide 12b by a pair of cot rolls (rocking rolls) 13. The undrawn yarn so rewound is taken up from the cot rolls 13 successively through fixing pins 14a and 14b and is wound at least one turn around a hot roller 15, at a pre-heating temperature of 60 to 80° C. The preheated undrawn yarn is then drawn preparatorily at a draw ratio of 1.1 to 1.5 between the cot roll 13 and the hot roll 15 and is further fed from the hot roll 15 to a plate heater 16. While keeping contact with the plate heater 16, the yarn is heated to a temperature of 120 to 230° C., for example, is taken up while being wound at least three turns around a drawing roller 17 and is thereafter drawn at a desired draw ratio of, for example, about 1.5 to 2.5, between the hot roll 15 and the stretch roller 17. The resulting drawn yarn 12c is wound around a rotating bobbin 18a fitted to a spindle winding up machine 18, to form a drawn filament yarn take-up cone 19.

In the drawing process described above, the undrawn filament yarn is drawn at a ratio lower than a natural draw ratio represented by a minimum ratio of a draw ratio region in which a necking phenomenone does not occur, at room temperature in the undrawn filament yarn. In this drawing process, the individual filament of the undrawn filament yarn is unevenly drawn while creating necking, and a plurality of thick portions and a plurality of thin portions (each having an uneven length) are alternately formed, thereby giving a stretched thick-and-thin yarn consisting of a plurality of drawn individual thick-and-thin conjugate filaments.

The process condition of the uneven drawing process (uneven in draw ratio, drawing temperature, drawing system (single time drawing system, plural times drawing system, etc.), drawing speed, etc) is controlled so that the mean value of the apparent thick-and-thin ratio of the resulting thick-and-thin filament yarn is at least 1.05, preferably at least 1.2 and more preferably 1.5 to 2.0. The apparent thick-and-thin ratio is represented by the ratio of the maximum thickness to the minimum thickness of the drawn thick-and-thin filament yarn in the region of the 10 cm length of the filament yarn measured using an electron microscope as explained above.

In the thick-and-thin filament yarn drawn by the process described above, the thick and thin portions each having an uneven length are alternately formed in each of the individual thick-and-thin filaments constituting the thick-and-thin filament yarn. Therefore, in the multifilament yarn, the thick and thin portions of the individual filaments contained in the multifilament are distributed at random. For this reason, the thick and thin portions having uneven lengths are alternately formed as a whole in the multifilament yarn, and the distributions of thickness and characteristics (thermal shrinkage ratio, mechanical strength, dyeability, stretchability, etc) of the individual filaments in the multi-filament become random. Therefore, these characteristics can be handled, as substantially uniform, in the same way as in the drawn filament yarn having a uniform thickness. When the drawn thick-and-thin filament yarn of the invention is dyed, for example, coloration having a substantially uniform hue and density, as a whole, can be obtained.

In the process of the invention, a false twisting or twisting procedure is applied to the thick-and-thin filament yarn described above, whenever necessary, and is then used to produce the fabric. In this instance, the fabric is preferably a woven fabric or a knitted fabric as already described. Further, the fabric preferably contains at least 30% by mass of the thick-and-thin multifilament yarns and more preferably at least 40% by mass.

The structure of the fabric is not particularly limited. The thick-and-thin multifilament yarns may be used independently as warp and/or weft yarns. The multifilament yarns may be combined with other filament yarns and may be used as mixed filament yarns or a twist-combined yarns.

In a preferred woven fabric structure of the thick-and-thin filament yarn of the present invention, the weave structure preferably has a warp density of 70 to 90 warps/2.54 cm, a weft density of 55 to 65 wefts/2.54 cm and a cover factor (CF) of 1,200 to 1,700. In the case of the twill woven fabric, the structure preferably has a warp density of 90 to 120 warps/2.54 cm, a weft density of 75 to 95 wefts/2.54 cm and a cover factor of 1,700 to 2,300.

The cover factor (CF) is calculated in accordance with the following equation:

CF=(DWp/1.1)^{1/2}×MWp+(DWf/1.1)^{1/2}×MWf

where DWp: total thickness (dtex) of warps,

MWp: weave density (warps/2.54 cm) of warps,

DWf: total thickness of wefts,

MWf: weave density of wefts.

In the process of the invention, an alkali mass-reduction treatment at a mass-reduction ratio of 3 mass % to 30 mass % and preferably 10 mass % to 20 mass % is applied to the thick-and-thin filament yarn fabric. This alkali mass-reduction treatment causes a plurality of cracks extending from the peripheral surface of the individual polyester conjugate filaments to be created in the thick-and-thin filament yarn fabric in a direction intersecting the filament axis. The conditions of the alkali mass-reduction treatment such as the kind of an alkali, an alkali concentration, a treating temperature, a treating time, a treating bath ratio, etc, may be established appropriately so that desired cracks can be formed. Generally, caustic alkali (caustic soda and/or caustic potash) is used as an aqueous solution having a concentration of 20 to 40 g/liter at a temperature of 80 to 95° C. for a treating time of 1 to 2 hours and at a bath ratio of 1:10 to 1:30.

In the process of the invention, at least one of scouring, pre-heat set, dyeing, final heat set, etc, may be applied before and/or after the alkali mass-reduction treatment described above, whenever necessary.

A plurality of cracks formed on the peripheral surface of the individual polyester conjugate filaments contained in the thick-and-thin filament yarn of the invention makes the hand of the thick-and-thin multifilament yarn, and the hand of the fabric containing such a filament yarn, soft, and scatters and absorbs light on the peripheral surface in the same way as the scales of a wool fiber. The individual conjugate filament is a thick-and-thin filament and the multifilament yarn consisting of such filaments is also a thick-and-thin yarn, too. As a result, the thick-and-thin filament yarn fabric according to the invention can exhibit a hand and an appearance analogous to those of a natural fiber spun filament yarn fabric, particularly a worsted filament yarn. The individual filament constituting the thick-and-thin filament yarn have the side-by-side type or eccentric core-in-sheath type or two-component polyester conjugate filament structure. Therefore, the individual conjugate filament is crimped due to the difference of heat shrinkage ratios of both component polyesters, and the resulting thick-and-thin filament yarn and its fabric exhibit excellent stretchability.

### EXAMPLES

The present invention will be further explained by the following Examples.

The following test measurements were carried out in the Examples and Comparative Examples.

(1) Intrinsic Viscosity of Polyester

The intrinsic viscosity was measured in an orthochlorophenol solution of each polyester sample at 30° C.

(2) Natural Draw Ratio

A natural draw ratio was represented by strain at a point at which a stress started rising in a stress-strain curve of an undrawn multifilament yarn sample at normal temperature.

(3) Apparent Thick-and-Thin Ratio of Filament Yarn

The apparent thick-and-thin ratio was represented by a ratio of a maximum thickness to a minimum thickness in a 10 cm length region of a filament yarn when a drawn multifilament yarn sample was observed through an electron microscope.

(4) Hand and Appearance of Fabric

Hand of each sample fabric analogous to hand of a worsted filament yarn fabric, its appearance analogous to that of a natural fiber spun filament yarn fabric and its hand and stretchability analogous to those of the natural fiber spun filament yarn fabric were evaluated functionally by three panelists in three stages, and a mean value was determined.

extremely excellent: 3 points (superior)

fair: 2 points (fair)

inferior: 1 point (inferior)

Overall evaluation was represented by the lowest point of each of the items described above, the softness and the silhouette (appearance).

### Example 1

Polyethylene terephthalate type copolymeric polyester containing 10mol % of a copolymerized isophthalic acid component on the basis of the total acid components and having an intrinsic viscosity of 0.65 was used as a high intrinsic viscosity polyester, and a polyethylene terephthalate having an intrinsic viscosity of 0.45 was used as a low intrinsic viscosity polyester. Both polyesters were melt-spun at a mass ratio of 50:50 into a side-by-side type multifilament yarn. In the conjugate filament-meltspinning procedure, the spinning temperature was 288° C. and a take-up speed was 1,400 m/min. The resulting undrawn multifilament yarn was taken up without drawing, and an undrawn yarn consisting of conjugate filaments and having a yarn count of 335 dtex/24 fil, an elongation at break of 360% and a natural draw ratio of 2.5 times was obtained.

The undrawn yarn was subjected to the drawing process shown in FIG. 3, and a multifilament (yarn count: 140 dtex/24 fil, elongation at break: 28%, boiling water shrinkage ratio: 20%) consisting of conjugate filaments and having an apparent thick-and-thin ratio of 1.2 was produced. The drawing condition was as follows. A draw ratio between the cot roller 2 and the hot roller 3 was 1.2, the draw ratio between the hot roller 3 and the drawing roller 6 was 2.0. the surface temperature of the plate heater 5 was 140° C., and the peripheral speed of the drawinging roller 6 was 600 m/min.

Twist of 1,200 turns/m was imparted in a customary manner to the resulting thick-and-thin multifilament yarn and the yarn so twisted was used for both warp and weft to weave a plain (tropical) weave in a warp density of 74 warps/2.54 cm and a weft density of 60 wefts/2.54 cm. A cover factor of this plain weave was 1,512. Then, this woven fabric was scoured, subjected to an alkali mass-reduction treatment (mass-reduction of 15%), dyed and subjected to final heat set to obtain a fabric that was like a worsted yarn fabric.

When the resulting thick-and-thin yarn fabric was observed through an electron microscope, cracks formed on the peripheral surface of the individual conjugate filaments and having, in mean values of the data of ten measurements, i.e. n=10, a width of 1.0 μm, a depth of 3.0 μm, a crack interval of 2.0 μm, a linear distance between both ends of ¼ to 1/1 of a mean diameter of individual filament of 28 μm, that is, about 7 to 28 μm, and a crack distribution density at a thick portion of 250 cracks/mm were found.

The resulting thick-and-thin filament yarn fabric had good hand and appearance analogous to those of a worsted yarn fabric. The fabric had good hand, and appropriate bulkiness, stretchability and stiffness like those of a natural fiber spun yarn fabric. Because this fabric had gracious drape property, it looked as if it were a wool woven fabric. Further, the resulting thick-and-thin yarn fabric had excellent stretchability and gave a pleasant hand in use.

Table 1 shows the apparent thick-and-thin ratio and the length of the thick portions of the resulting thick-and-thin filament yarn, and the evaluation results of the worsted yarn fabric-like hand, the natural fiber spun yarn fabric-like appearance and hand of the resulting thick-and-thin filament yarn fabric and the stretchability and overall evaluation of the fabric.

### Example 2

A polyester thick-and-thin filament yarn fabric was produced in the same way as in Example 1. However, the fabric structure was a 2/2 twill weave (serge) structure having the following properties:

warp density: 102 warps/2.54 cm

weft density: 84 wefts/2.54 cm

cover factor (CF): 2,094

The cracks formed on the peripheral surface of the individual thick-and-thin filaments of the resulting fabric had the following properties in the mean values of the results of measurement made ten times, i.e. n=10:

crack width: 1.0 μm

crack depth: 3.0 μm

crack interval: 2.0 μm

linear distance between both ends: ¼ to 1/1 of the mean diameter 28 μm of filament, i.e. 7 to 28 μm crack density at thick portions: 250 cracks/mm

The resulting fabric had a hand and appearance analogous to those of the fabric of Example 1. Table 1 shows the evaluation results of the fabric.

### Comparative Example 1

The same undrawn polyester multifilament yarn as the one used in Example 1 was processed to give a drawn multifilament yarn having an apparent thick-and-thin ratio of 1.0 in the same way as in Example 1 with the exception that a preparatory draw ratio was 1.1 and a draw ratio on the plate heater was 3.0.

A plain weave fabric was produced by use of this drawn multifilament yarn in the same way as in Example 1 and the resulting fabric was subjected to the alkali mass-reduction treatment.

The following cracks were formed on the peripheral surface of the individual filaments of the resulting fabric, in the mean values of the ten measurements, i.e. n=10:

crack width: 1.0 μm

crack depth: 2.0 μm

crack gap: 2.0 μm

linear distance between both ends: 1/10 to ⅕ of mean diameter 28 μm, i.e. 3 to 6 μm

crack density: 50 cracks/mm

Table 1 shows the evaluation results of the fabric.

This fabric was unsatisfactory in hand and was not analogous, in hand, to a natural fiber spun filament yarn fabric.

### Comparative Example 2

A thick-and-thin filament yarn fabric was produced in the same way as in Example 1 with the exception that the alkali mass-reduction treatment was omitted.

Formation of the cracks was not found on the peripheral surface of the individual filaments of the thick-and-thin filament yarn in the resulting fabric.

Table 1 shows the evaluation result of this fabric. The fabric was unsatisfactory in the hand which was not analogous to the hand of the worsted yarn fabric.

TABLE 1

| | Form of thick-and- | | | | | | |
|---|---|---|---|---|---|---|---|
| | thin multifilament | | Properties of fabric | | | | |
| | Thick | Length | Worsted | Natural fiber | Natural fiber | | |
| | to | of | yarn | spun yarn | spun yarn | | |
| | thin | thick | fabric-like | fabric-like | fabric-like | Stretch- | Overall |
| | ratio | portions | hand | appearance | hand | ability | evaluation |
| Example 1 | 1.2 | 30 mm or | 3 | 3 | 3 | 3 | 3 |
| | | below | | | | | |
| Example 2 | 1.2 | 30 mm or | 3 | 3 | 3 | 3 | 3 |
| | | below | | | | | |
| Comparative 1 | 1.0 | — | 3 | 3 | 1 | 3 | 1 |
| Example | | | | | | | |
| Comparative 2 | 1.2 | 30 mm or | 1 | 2 | 3 | 3 | 1 |
| Example | | below | | | | | |

Industrial Applicability of the Invention

The thick-and-thin filament yarn fabric according to the invention is excellent in hand analogous to that of a worsted yarn fabric and hand and appearance analogous to those of a natural fiber spun yarn fabric, has an excellent stretchability and is extremely useful for practical application.

1. (Amended) A polyester conjugate filament thick-and-thin yarn fabric, comprising side-by-side type conjugate multifilament yarns or eccentric core-in-sheath type conjugate multifilament yarns of which, a portion of the peripheral surface of the each individual filament is formed by a portion of the eccentric core portion, characterized in that a plurality of individual filaments, from which the conjugate multifilament yarn is formed, are thick-and-thin filaments each comprising a plurality of thick portions and a plurality of thin portions each formed along the longitudinal axis direction of each individual filament, arranged alternately with each other and having uneven lengths and, when the conjugate multifilament yarn is observed by an electron microscope, an average value of an apparent thick-to-thin ratio represented by a ratio of a largest thickness to a smallest thickness of the yarn measured in a region of a length of 10 cm of the yarn, is 1.05 or more, and each of the plurality of individual filaments, from which the conjugate multifilament yarn is formed, has a plurality of cracks formed in the peripheral surface of the filament and extending in a direction intersecting the filament axis.

2. The polyester conjugate filament thick-and-thin yarn fabric as claimed in claim 1, wherein each crack is formed along a plane intersecting, substantially at right angles, the axis direction of the individual filament on which the crack is formed.

3. The polyester conjugate filament thick-and-thin yarn fabric as claimed in claim 1 or 2, wherein the cracks have an average width of 0.1 μm or more.

4. The polyester conjugate filament thick-and-thin yarn fabric as claimed in claim 1 or 2, wherein the cracks have an average straight line distance between the both ends thereof in the range of from ¼ to 1/1 of the average diameter of the individual filaments on which the cracks are formed.

5. The polyester conjugate filament thick-and-thin yarn fabric as claimed in claim 1 or 2, wherein the cracks are formed at intervals of 2 mm or less along the axis direction of the individual filament on which the cracks are formed.

6. The polyester conjugate filament thick-and-thin yarn fabric as claimed in claim 1, wherein the polyester conjugate filament thick-and-thin yarns are contained in a content of 30% by mass based on the total mass of all the yarns from which the fabric is formed.

7. A process for producing a polyester conjugate filament thick-and-thin yarn fabric comprising:
separately melting a polyester resin having an intrinsic viscosity of 0.3 to 0.9, determined in orthochlorophenol at 30° C., and an other polyester resin having an intrinsic viscosity of 0.1 to 0.5 above the intrinsic viscosity of the former polyester resin; extruding the melts of the two types of the polyester resins through a side-by-side type conjugate multifilament-forming spinneret or an eccentric core-in-sheath type conjugate multifilament-forming spinneret, to form conjugate multifilaments; winding up the resultant side-by-side type undrawn conjugate multifilament yarn or eccentric core-in-sheath type undrawn conjugate multifilament yarn at a speed of 1,000 to 4,500 m/minute; while unwinding the wound undrawn conjugate multifilament yarn, unevenly drawing the unwound undrawn conjugate multifilament yarn in the filament axis direction at a draw ratio lower than the natural draw ratio of the undrawn multifilament yarn represented by a lowest draw ratio in a draw ratio range in which the undrawn multifilament yarn can be drawn at room temperature without necking of the filaments, to produce a drawn thick-and-thin yarn comprising a plurality of drawn thick-and-thin conjugate filaments each having a plurality of thick portions and a plurality of thin portions arranged alternately with each other and having uneven lengths, respectively, while the unevenly drawing procedure is controlled so that when the resultant drawn thick-and-thin yarn is observed by an electron microscope, an apparent thick-to-thin ratio represented by a ratio of a largest thickness to a smallest thickness of the yarn in a region in a length of 10 cm of the yarn, is 1.05 or more;
producing a fabric comprising the drawn conjugate multifilament thick-and-thin yarn; and
subjecting the fabric to a mass-reduction treatment with an alkali at a mass-reduction of 3% or more but not more than 30%, to thereby cause a plurality of cracks to be formed in the peripheral surfaces of the individual conjugate polyester filaments in a direction intersecting the axes of the individual conjugate polyester filaments.

8. The process for producing polyester conjugate filament thick-and-thin yarn fabric as claimed in claim 7, wherein a difference in the intrinsic viscosity between the two polyester resins for forming the conjugate filaments is 0.1 to 0.5.

9. The process for producing polyester conjugate filament thick-and-thin yarn fabric as claimed in claim 7, wherein one of the two types of filament-forming polyester resins comprises a polyethylene terephthalate copoloymer or a polybutylene terephthalate copolymers containing 30 molar % or less of at least one copolymerized comonomer selected from the group consisting of isophthalic acid, diphenyldicarboxylic acids, naphthalene dicarboxylic acids, 5-sodium sulfoisophthalic acid, adipic acid, sebacic acid, parahydroxybenzoic acid, p-(β-hydroxy) benzoic acid, trimethylene glycol, hexamethylene glycol, neopentyl glycol, bisphenol A and polytetramethylene glycol, and the other one of the two types of polyester resins consists essentially of a polyethylene terephthalate or a polybutylene terephthalate.

10. The process for producing polyester conjugate filament thick-and-thin yarn fabric as claimed in claim 7, wherein the mass ratio of the two types of filament-forming polyester resins to each other is in the range of from 20:80 to 80:20.
